(19) United States
(12) Patent Application Publication
(10) Pub. No.: US 2014/0207434 A1
(43) Pub. Date: Jul. 24, 2014

(54) VIRTUAL MODEL MERGING SYSTEMS AND METHODS

(71) Applicant: GM GLOBAL TECHNOLOGY OPERATIONS LLC, Detroit, MI (US)

(72) Inventors: Ritesh Goyal, Bangalore (IN); Onassis Matthews, Novi, MI (US)

(73) Assignee: GM Global Technology Operations LLC, Detroit, MI (US)

(21) Appl. No.: 13/766,252

(22) Filed: Feb. 13, 2013

(30) Foreign Application Priority Data
Jan. 21, 2013 (IN) 72/KOL/2013

(51) Int. Cl. G06F 17/50

(52) U.S. Cl. CPC G06F 17/5095
USPC 703/8

(57) ABSTRACT

A method includes: indicating a first and second virtual models selected by a user; and generating a list including: a first set of names of object blocks that are in the first virtual model but that are not in the second virtual model; and a second set of names of object blocks that are in the second virtual model but that are not in the first virtual model. The method further includes: selectively displaying the first and second sets of names on a display; and, in response to user input to merge object blocks from the first virtual model to the second virtual model: copying the object blocks from the first virtual model to the second virtual model; and connecting the object blocks in the second virtual model based on connections between the object blocks in the first virtual model.

### CROSS-REFERENCE TO RELATED APPLICATIONS

This application claims the benefit of Indian Patent Provisional Application No. 72/KOL/2013 filed Jan. 21, 2013. The disclosure of the above application is incorporated herein in its entirety.

### FIELD

The present disclosure relates to vehicle systems and more specifically to virtual modeling of vehicle systems.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Model-based design tools enable users to design virtual models of time-varying systems. For example, control modules of a vehicle may be designed using Simulink or another suitable model-based design tool. A user may create a virtual model of a plant (e.g., an engine, a transmission, etc.) of a vehicle via Simulink. A user may also create a virtual model of a control module (e.g., engine control module, transmission control module, etc.) that controls a plant or another suitable system via Simulink.

A virtual model can include multiple subsystems. A subsystem can include multiple subsystems, and so on. More than one user may be tasked with maintenance and design of different portions of a virtual model. For example, multiple users may each be tasked with designing one or more subsystems of a virtual model. When multiple users need to change their respective portions of the model, the users edit their respective portions of the model as desired one user at a time until all of the changes have been made.

### SUMMARY

A virtual modeling system includes a model selection module, a user interface (UI) module, and a merging module. The model selection module indicates a first virtual model selected by a user and indicates a second virtual model selected by the user. A list includes: a first set of names of object blocks that are in at least one subsystem of the first virtual model but that are not in at least one subsystem of the second virtual model; and a second set of names of object blocks that are in the at least one subsystem of the second virtual model but that are not in the at least one subsystem of the first virtual model. The UI module selectively displays the first and second sets of names on a display. In response to user input to merge object blocks from the first virtual model to the second virtual model, the merging module: copies the object blocks from the first virtual model to the second virtual model; and connects the object blocks in the second virtual model based on connections between the object blocks in the first virtual model.

A virtual modeling method includes: indicating a first virtual model selected by a user; indicating a second virtual model selected by the user. The method further includes generating a list including: a first set of names of object blocks that are in at least one subsystem of the first virtual model but that are not in at least one subsystem of the second virtual model; and a second set of names of object blocks that are in the at least one subsystem of the second virtual model but that are not in the at least one subsystem of the first virtual model. The method further includes: selectively displaying the first and second sets of names on a display; and, in response to user input to merge object blocks from the first virtual model to the second virtual model: copying the object blocks from the first virtual model to the second virtual model; and connecting the object blocks in the second virtual model based on connections between the object blocks in the first virtual model.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example modeling system according to the present disclosure;

FIG. 2 is an example diagram of an example virtual model of a system of a vehicle according to the present disclosure;

FIG. 3 is an example diagram of the virtual model of FIG. 2 with multiple subsystem blocks according to the present disclosure;

FIG. 4 is an example diagram of a revised version of the virtual model of FIG. 2 according to the present disclosure;

FIG. 5 is a functional block diagram of an example implementation of a modeling module according to the present disclosure;

FIG. 6 is an example illustration of a compare and merge graphical user interface on a display according to the present disclosure;

FIG. 7 is a flowchart depicting an example method of comparing first and second virtual models according to the present disclosure; and

FIG. 8 is a flowchart depicting an example method of merging blocks and connections from a selected portion of one virtual model to a corresponding portion of another virtual model according to the present disclosure.

### DETAILED DESCRIPTION

Virtual modeling tools, such as Simulink, can be used to create virtual models of vehicle components and systems. A virtual model can include one or more subsystems, a subsystem can include one or more subsystems, and so on. Multiple users may be responsible for designing and editing different portions of a virtual model. For example, one user may be responsible for designing and editing a first subsystem of a virtual model and another user may be responsible for designing and editing a second subsystem of the virtual model.

The users may take turns opening the virtual model, editing their respective portions of the virtual model, and re-saving the virtual model. This process, however, takes time as only one user can edit their portions of the virtual model at a time. The present application involves systems and methods for comparing two virtual models and/or merging functionality from one virtual model to another virtual model. The ability to merge functionality from one virtual model to another virtual model enables multiple users to edit portions of a virtual model simultaneously as the portions of the virtual model can be merged back into the virtual model as desired.

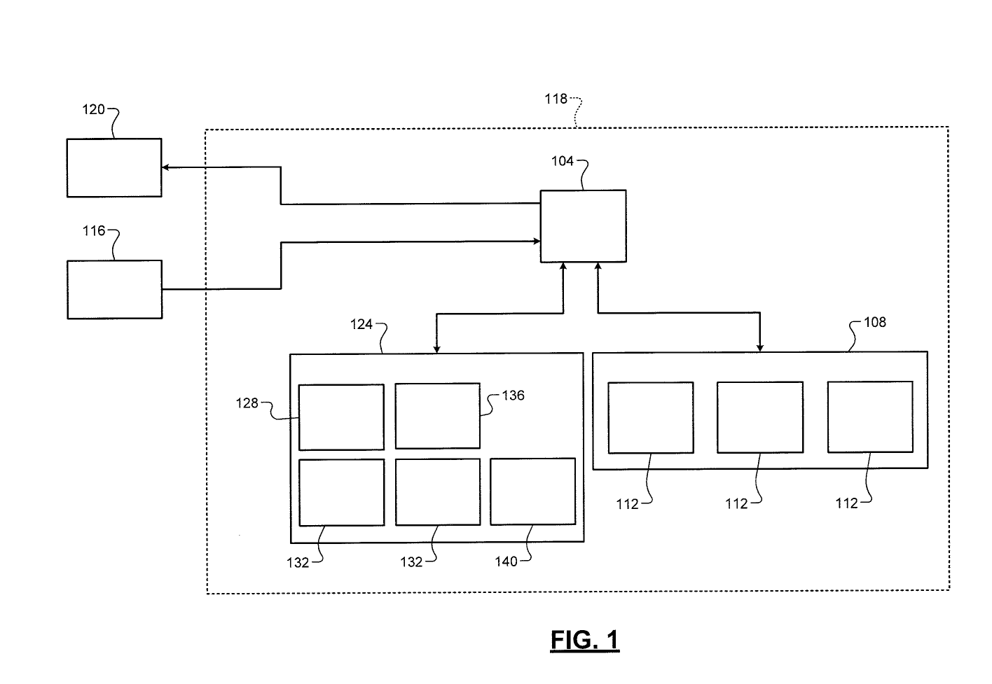

Referring now to FIG. 1, a functional block diagram of an example modeling system is presented. A modeling module 104 generates virtual models of systems of a vehicle. The modeling module 104 may execute Simulink or another suitable model-based design tool.

Files for the virtual models may be stored in a model library 108 or in another suitable location, for example, in memory. For example only, files for three different virtual models 112 are illustrated as being stored in the model library 108 in the example of FIG. 1. Virtual models may be stored using a predetermined file format for virtual models.

The modeling module 104 generates a virtual model of a system of a vehicle based on user input. The modeling module 104 receives user input via one or more user input devices 116, such as a keyboard and/or a mouse. The modeling module 104 displays a model-design environment on a display 120 for a user to create, edit, and design virtual models. In various implementations, a touchscreen display may be used, and the modeling module 104 may additionally or alternatively receive user input via the touchscreen display. A computer 118 may include all or a portion of the modeling module 104 and/or all or a portion of the modeling module 104 may be located remotely and accessed via a network.

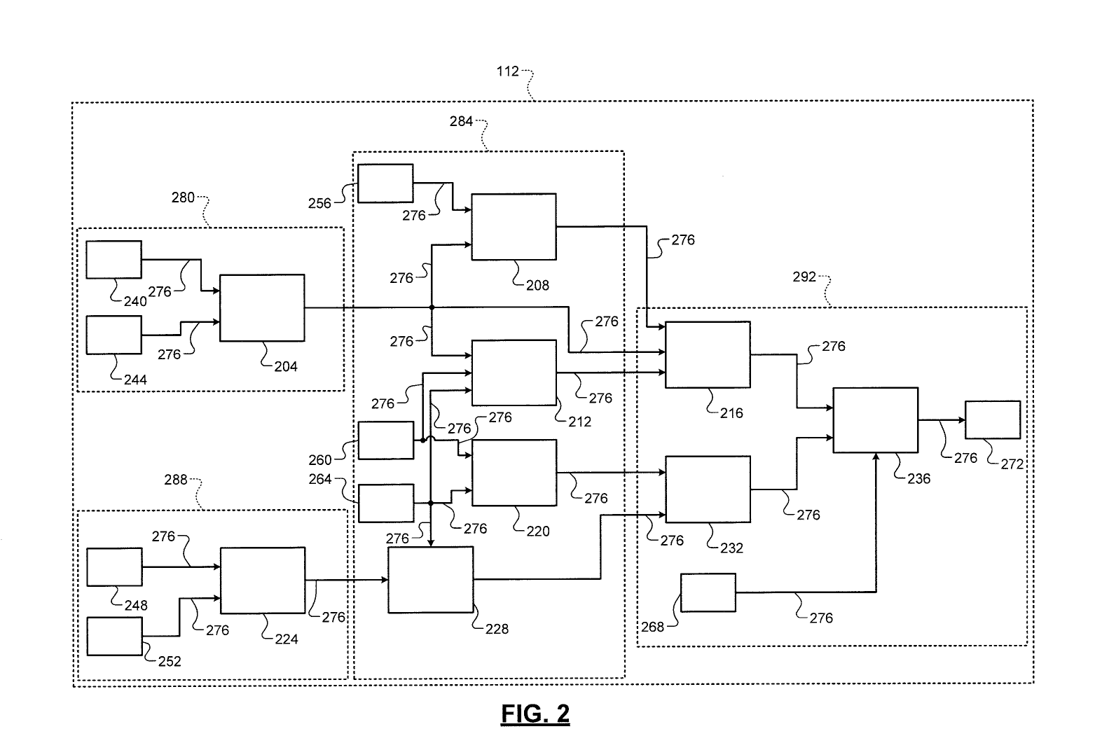

A virtual model of a system may refer to a user designed functional block diagram of the system. FIG. 2 includes an example functional block diagram of one of the virtual models 112. Referring now to FIGS. 1 and 2, a block library 124 may include blocks for objects having predetermined characteristics that a user can use to create virtual models. For example, in the example of FIG. 1, the block library 124 includes connectors 128, two function blocks 132, port block 136, and model block 140. While the example objects are shown and discussed, the block library 124 may include more blocks. Additionally or alternatively, blocks may be stored remotely and accessed via a network.

A virtual model may include function blocks, connectors, and port blocks (input ports and output ports). Function blocks, such as the function blocks 132, may include blocks that each perform an associated function that generates one or more outputs given one or more inputs. For example only, function blocks may include an Integrator block (that performs mathematical integration), a Unit Delay block (that delays receives input and delays the output of the input a predetermined number of units of time), a Sum block (that performs a mathematical sum), a Difference block (that determines a mathematical difference), a Lookup Table block (that determines a value based on a set of inputs using a lookup table), and other types of function blocks.

Function blocks may also include structural blocks that represent structural components that each perform associated functions, such as a Multiplexer (Mux) block, a De-Mux block, a Switch block, a Selector block, and other types of blocks that represent structural/hardware components. Function blocks may also include Code blocks that execute user input machine code (e.g., C-based code, Fortran code, Ada code, etc.). Connectors, such as the connector 128, may include objects for establishing connections between blocks to establish relationships between blocks. Port blocks, such as the port block 136, may include input port blocks and output port blocks.

A user can add objects from the block library 124 to a virtual model and delete objects from the virtual model. For example only, a user can add objects from the block library 124 to a virtual model by dragging objects from the block library 124 to the virtual model. A user can customize characteristics of objects of a virtual model to customize the virtual model for the vehicle system. A user can store customized objects in the block library 124, for example, for later re-use.

In the example of FIG. 2, the virtual model 112 includes first, second, third fourth, fifth, sixth, seventh, eighth, and ninth function blocks 204, 208, 212, 216, 220, 224, 228, 232, and 236. The virtual model 112 also includes first, second, third fourth, fifth, sixth, seventh, and eighth input port blocks 240, 244, 248, 252, 256, 260, 264, and 268 and an output port block 272. The virtual model 112 also includes connectors, which are commonly numbered 276.

A user can group objects of a virtual model together into a subsystem. A subsystem encapsulates a group of selected blocks and signals into a single (subsystem) block in the virtual model. Groups of objects of a subsystem can also be grouped into one or more subsystems, and so on. Subsystems of a virtual model can also be referred to as virtual models in the sense that subsystems are sub-models of a virtual model.

Grouping selected blocks and signals into subsystems may enable organization of a virtual model into manageable hierarchical levels. The virtual model may be considered a first level in a hierarchy, subsystems of the virtual model may be considered a second level of the hierarchy, subsystems of a subsystem may be considered a third level of hierarchy, etc.

In the example of FIG. 2, for example, the first function block 204 can be grouped with the first and second input ports 240 and 244 and the associated connectors 276 into a first subsystem 280. The second, third, fifth, and seventh function blocks 208, 212, 220, and 228 can be grouped with the fifth, sixth, and seventh input port blocks 256, 260, and 264 and the associated connectors 276 into a second subsystem 284. The sixth function block 224 can be grouped with the third and fourth input blocks 248 and 252 into a third subsystem 288. The fourth, eighth, and ninth function blocks 216, 232, and 236 can be grouped with the eighth input port block 268 and the output port block 272 into a fourth subsystem 292. The four subsystems are examples only and objects of a virtual model can be grouped into subsystems as desired by a user.

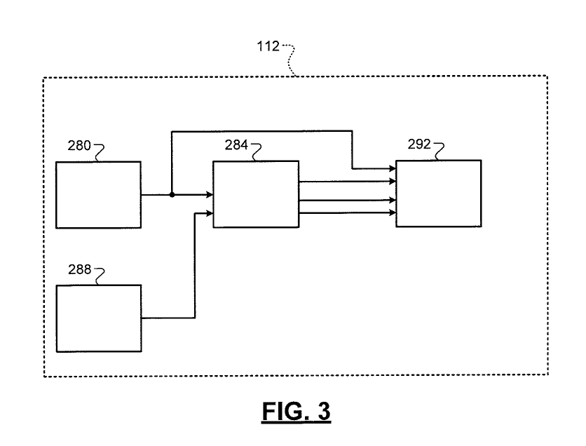

Once objects of a virtual model are grouped into a subsystem by a user, the modeling module 104 removes those objects from the display 120 and replaces them with a subsystem block. For example, FIG. 3 includes an example diagram of the virtual model 112 of FIG. 2 with subsystem blocks for the first, second, third, and fourth subsystems 280, 284, 288, and 292. A user can view and edit the objects of a subsystem, for example, by double clicking the subsystem block.

Two or more different users may be tasked with designing and editing different portions of a virtual model. For example, a first user may be tasked with designing and editing the first and third subsystems 280 and 288, a second user may be tasked with designing and editing the second subsystem 284, and a third user may be tasked with designing and editing the fourth subsystem 292.

Because the first, second, and/or third users would each have to make changes to the virtual model 112 and the virtual model 112 should reflect each user's changes, the first, second, and third users may have to take turns opening the virtual model 112, designing and editing their portions of the virtual model 112, and re-saving the virtual model 112. This process, however, takes time as the first, second, and third users may have to wait to design their portions of the virtual model 112.

The modeling module 104 of the present application enables users to simultaneously design portions of a virtual model. The users each store the virtual model including their designed portions of the virtual model as a different file. The modeling module 104 selectively compares selected portions (e.g., one or more subsystems) of two selected virtual models to identify differences between the selected portions of the two virtual models.

The modeling module 104 selectively merges the blocks and the associated connections from the selected portion(s) of one of the two selected virtual models to the selected portion(s) of the other one of the two selected models. The modeling module 104 may also remove blocks and connectors from the other one of the two selected virtual models that are not present in the one of the two selected virtual models. This allows multiple users to edit their respective portions of a virtual model simultaneously and to merge their respective portions back into the virtual model. A portion may refer to a whole virtual model or less than the whole virtual model.

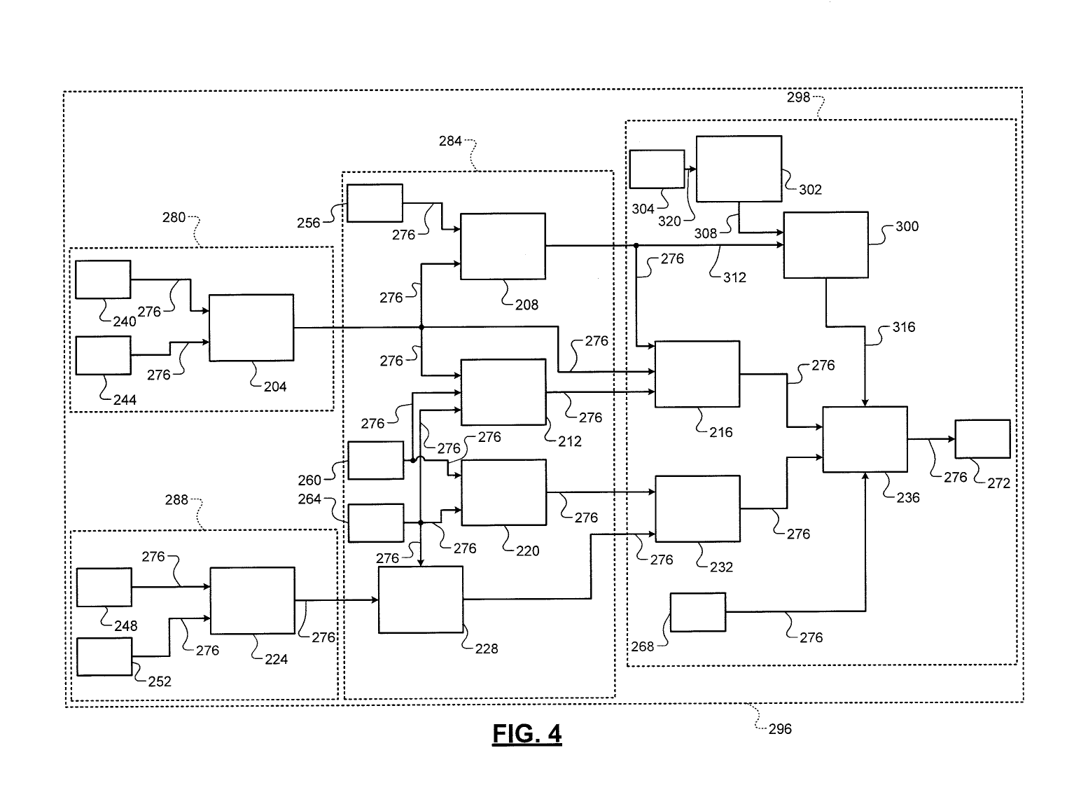

FIG. 4 includes a diagram of a virtual model 296 with a re-designed fourth subsystem 298. In the example of FIG. 4, a tenth function block 300, an eleventh function block 302, and a ninth input port block 304, have been added to the fourth subsystem 292. First, second, third, and fourth connectors 308, 312, 316, and 320 have also been added to the fourth subsystem 292. A user saves the virtual model 296 in a different file than the virtual model 112 of FIG. 2.

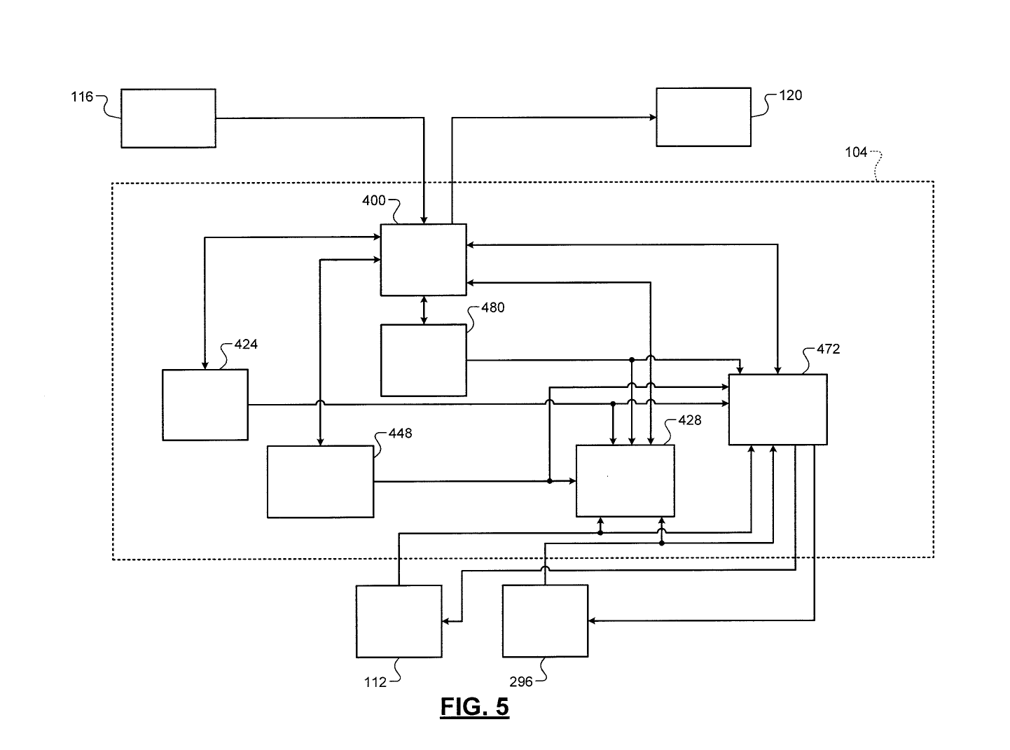

FIG. 5 includes a functional block diagram of an example implementation of the modeling module 104. Referring now to FIGS. 4 and 5, a user interface (UI) module 400 relays user input to modules of the modeling module 104 and controls user output to the display 120. The UI module 400 selectively renders a compare and merge graphical user interface (GUI) on the display 120. For example, the UI module 400 may render the compare and merge GUI on the display 120 in response to user input to compare and/or merge functionality of two virtual models.

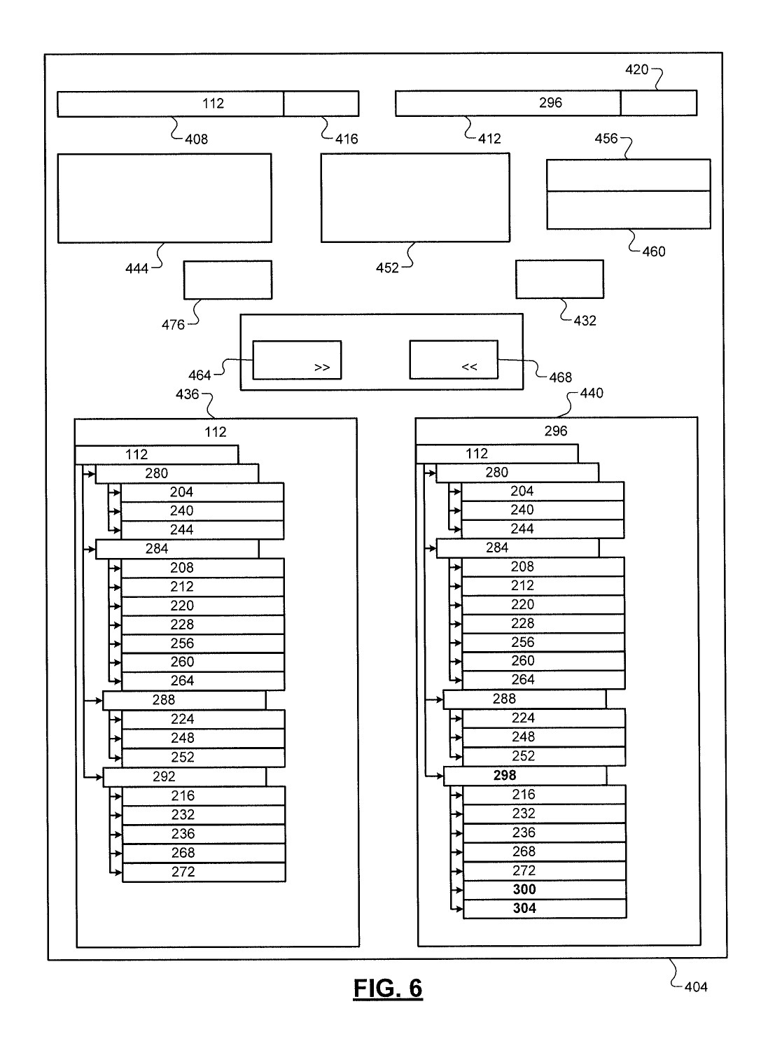

FIG. 6 includes an example illustration of the compare and merge GUI 404. Referring now to FIGS. 5 and 6, a user selects the files associated with first and second virtual models via first and second model path fields 408 and 412. First and second file browser fields 416 and 420 may be provided with the first and second model path fields 408 and 412. Via the first and second file browser fields 416 and 420, a user can search for and select files associated with virtual models. Selection of the virtual models 112 and 296 is shown and will be discussed as an example, but other virtual models can be selected. A model selection module 424 communicates indicators of the first and second virtual models selected by the user via the first and second model fields 408 and 412.

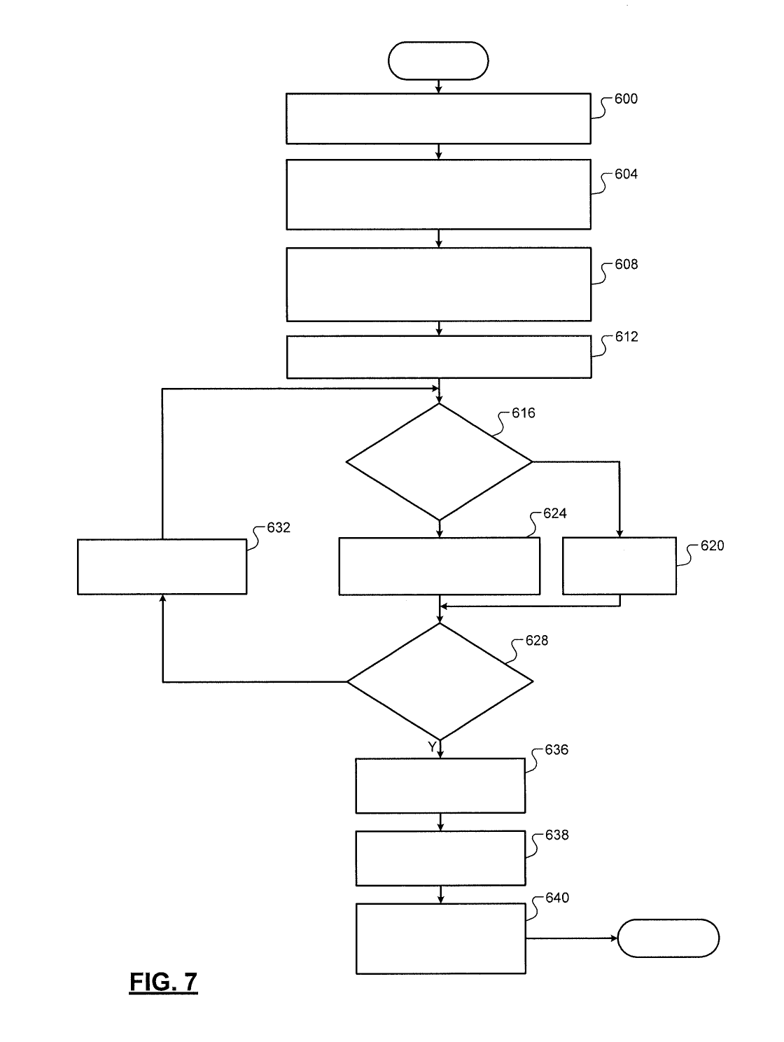

In response to user selection of a comparison input 432, a comparison module 428 compares the blocks of the first and second virtual models. The comparison module 428 may compare the first and second virtual models as wholes or one or more selected portions (e.g., subsystems) of the first and second virtual models. Operation of the comparison module 428 will be discussed in conjunction with the example of FIG. 7.

FIG. 7 includes a flowchart depicting an example method of comparing the first and second virtual models that may be performed by the comparison module 428. While the example method of FIG. 7 is provided and described, another suitable method of comparing virtual models may be used. Control may begin with 600 where indications of the first and second virtual models selected by the user are received. At 604, control identifies the names of the blocks of a first (hierarchical) level of the first virtual model and identifies the names of the blocks of the first level of the second virtual model. The blocks may include subsystem blocks and other types of object blocks.

At 608, control updates a first list with the names of the blocks of the first virtual model, and control updates a second list with the names of the blocks of the second virtual model. Control selects one of the names from one of the first and second lists at 612, and control continues with 616. At 616, control determines whether the selected name is in the other one of the first and second lists. In other words, if control selects a name from the first list at 612, control determines whether the selected name is in the second list at 616. The opposite is true if control selects a name from the second list.

If the selected name is in the other one of the first and second lists, control adds the selected name to a common list at 620, and control continues with 628. In this manner, the common list includes the names of blocks that are included in both the first and second virtual models. If the selected name is not in the other one of the first and second lists, control adds the name to a difference list at 624, and control continues with 628. In this manner, the difference list includes the names of blocks that are included in only one of the first and second virtual models. Control also indicates which one of the first and second lists that the name is in when the selected name is not in the other one of the first and second lists.

At 628, control determines whether the names of the first and second lists have each been selected. If false, control selects a different one of the names from one of the first and second lists at 632, and control returns to 616. If true, all of the names have been selected from both the first and second lists, and control continues with 636. Control may select the names in a predetermined order or randomly.

Control may repeat 604-632 for each subsystem block named in the common list at 636. More specifically, control may identify and update the first list with the names of each block of each subsystem of the first virtual model that is named in the common block list. Control identifies and updates the second list with the names of each block of each subsystem of the second virtual model that is named in the common block list. Control adds blocks that are common to both of the first and second virtual models to the common list, and control adds blocks that are only in one of the first and second virtual models to the difference list. Control may repeat this process for each subsystem block of each subsystem named in the common list, and so on.

At 638, control selects a block listed in the common block list and compares characteristics (e.g., parameters and properties) of the corresponding blocks of the first and second virtual models. The characteristics are discussed further below. If one or more of the characteristics of the block of the first virtual model are different than the characteristics of the block of the second virtual model, control adds the selected block to the difference list. Control repeats this process for each block named in the common list. At 640, control generates and displays a hierarchical tree/tree diagram for each of the first and second virtual models on the display 120 based on the first, second, common, and difference lists. FIG. 6 includes an example of hierarchical trees 436 and 440 for the virtual models 112 and 296, respectively. The comparison module 428 displays the names in the first list in the tree 436 and displays the names in the second list in the tree 440.

The comparison module 428 may display the names of blocks that appear in the common list using a first type of visual indicator and display names of blocks that appear in the difference list using a second, different type of visual indicator. For example only, in the example of FIG. 6, the first type of visual indicator may be a normal font and the second type of visual indicator may be a bold font. In various implementations, size, font type, underlining, italics, strikethrough, color, shading, or another suitable type of visual indicator may be used. In various implementations, the comparison module 428 may selectively display only the differences between the first and second virtual models. The comparison module 428 may display only the differences between the first and second virtual models, for example, in response to user input indicative of a request to display only the differences.

The comparison module 428 may compare the blocks of the first and second virtual models for user selected differences. A variety of characteristics of each block can be user customized/edited. For example, color, name, position, function, number of inputs, number of outputs, and other characteristics of blocks can be user customized.

A user can select characteristics for use in identifying differences via a characteristics list field 444. A characteristic selection module 448 may add user selected characteristics to a selected characteristic field 452. In various implementations, the characteristic selection module 448 may select default characteristics and the user may add to and/or detract from the default characteristics.

A user can also select whether the characteristics in the selected characteristic field 452 should be excluded or should be the only characteristics used in performing the comparison via first and second comparison inputs 456 and 460, respectively. The characteristic selection module 448 may generate an indicator (e.g., a list) of the selected characteristics and an indicator of the one of the first and second comparison inputs 456 and 460 that is selected. The indicator(s) may be used as described above in comparing the selected characteristics of two virtual models.

A user can compare selected subsystems of the first and second virtual models via a subsystem comparison input 476. In response to user selection of the subsystem comparison input 476, the UI module 400 may generate a pop-up window with the hierarchical trees of the first and second virtual models. The user can select one or more subsystems of interest from a hierarchical tree and initiate the comparison. This may make the comparison faster and user specific.

In response to user selection of one of two merge inputs 464 and 468, a merging module 472 selectively copies/merges the blocks of selected portion(s) (e.g., one or more subsystems) from one of the first and second virtual models (“the source model”) to the other one of the first and second virtual models (“the destination model”). If a block is not present in the destination model, the merging module 472 merges the block from the source model to the destination model. The merging module 472 also connects the blocks of the portions of the destination model, using connectors, as they are connected in the source model. The merging module 472 may also delete blocks from the portions of the destination model, and associated connectors, that are not present in the source model.

For example, in response to the user selection of the merge input 464, the merging module 472 copies the blocks of selected portion(s) of the virtual model 112 to the virtual model 296 and connects the blocks within the virtual model 296 as they are connected in the virtual model 112. In response to the user selection of the merge input 468, the merging module 472 copies the blocks of selected portion(s) of the virtual model 296 to the virtual model 112 and connects the blocks within the virtual model 112 as they are connected in the virtual model 296.

A user can select one or more blocks to merge from the source model to the destination model. A block selection module 480 generates a block list indicating the block(s) selected by the user.

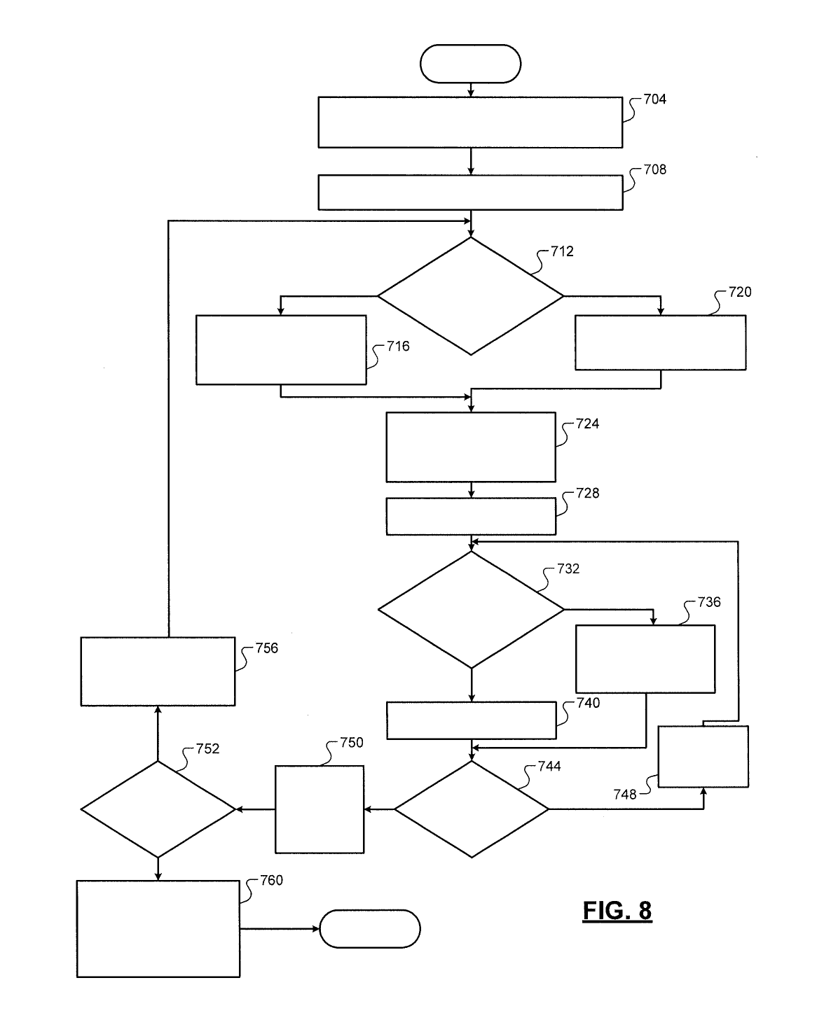

Operation of the merging module 472 will be discussed in conjunction with the example of FIG. 8. FIG. 8 includes a flowchart depicting an example method of merging blocks from selected portion(s) of a source model to destination model that may be performed by the merging module 472.

Control may begin at 704 where indications of the source and destination models selected by the user and the block list (the list of blocks of the source model selected by the user) are received. At 708, control selects one of the blocks from the blocklist. Control determines whether the selected block is in the corresponding portion (same hierarchical level) of the destination model. If true, control replaces the block in the corresponding portion of the destination model with the selected block from the source model at 716, and control continues with 724. If false, control copies the block from the source model to the corresponding portion of the destination model at 720, and control continues with 724.

At 724, control obtains connection information for the selected block from the source model. In other words, control obtains information indicating how inputs and outputs of the selected block are connected. At 728, control selects one of the connections of the selected block.

Control determines whether one or more other blocks that are needed for connection with the selected block are in the destination model. If false, as indicated by 736, control merges the one or more other blocks that are needed for connection using the same method (during a later iteration of 716 or 720), and control continues with 744. This makes the method a recursive method. If true, control continues with 740. At 740, control makes the selected connection between blocks in the destination model as the connection is made in the source model, and control continues with 744.

At 744, control determines whether all of the connections for the selected block have been selected. In other words, control determines whether all of the connections for the selected block have been made in the destination model. If false, control selects a different one of the connections at 748, and control returns to 732. If true, control continues with 750. Control propagates signal names from the source model to the destination model at 750. As described above, not only the selected blocks are merged from the source model to the destination model, but the related functionality of the blocks, the connections of the blocks, and the names are merged from the source model to the destination model.

Control determines whether all of the blocks have been selected from the block list at 752. If false, control may select a different one of the blocks of the block list at 756, and control returns to 712. If true, control may continue with 760. At 760, control may remove one or more blocks and connectors, if any, from the portion(s) of the destination model that are not present in the portion(s) of the source model. Control also removes any unconnected or partially connected connections from the destination model. Once the merging process has been performed, the destination model can be saved.

In sum, multiple users that are each responsible for different portions of the destination model can open a destination model. Each user can save the destination model in a different file, thereby creating multiple different versions of the destination model. The different versions of the destination model can each be used as source models in the future to merge the functionality of each of the respective portions of the different destination models back into the corresponding portions of the destination model.

The example of FIG. 8 will now be discussed using virtual model 296 as the source model and virtual model 112 as the destination model. As described above, the tenth function block 300 is not in the virtual model 112. Assume that only the tenth function block 300 is selected by the user for inclusion in the block list. At 712, control will recognize that the function block 300 is not in the virtual model 112. Thus, at 720, control will copy the tenth function block 300 from the virtual model 296 to the virtual model 112.

At 724, control will obtain the connection information for the tenth function block 300. More specifically, control will recognize that the connections 308 and 312 are the connections of the tenth function block 300. At 728, control selects either the connection 308 or the connection 312. Assuming that control selects connection 308, at 732, control determines that a block needed for the connection 308 (e.g., the eleventh function block 302) does not exist in the destination model. Control will then merge the non-existing blocks and the associated connections from the virtual model 296 into the virtual model 112 using the same method at 736. Thus, after 736, the virtual model 112 will also include the eleventh function block 302, the input port block 304, and the connections 308 and 312.

At 744, control will determine that the connection 312 has not yet been selected, and control will select the connection 312 at 748. At 732, control will determine that the block(s) for the connection 312 exist in the virtual model 112 and proceed with 740. Control will merge the connection 312 from the virtual model 296 to the virtual model 112 at 740.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

What is claimed is:

1. A virtual modeling system comprising:
a model selection module that indicates a first virtual model selected by a user and that indicates a second virtual model selected by the user;
a list including:
a first set of names of object blocks that are in at least one subsystem of the first virtual model but that are not in at least one subsystem of the second virtual model; and
a second set of names of object blocks that are in the at least one subsystem of the second virtual model but that are not in the at least one subsystem of the first virtual model;
a user interface (UI) module that selectively displays the first and second sets of names on a display; and
a merging module that, in response to user input to merge object blocks from the first virtual model to the second virtual model:
copies the object blocks from the first virtual model to the second virtual model; and
connects the object blocks in the second virtual model based on connections between the object blocks in the first virtual model.

2. The virtual modeling system of claim 1 further comprising a comparison module that:
in response to user input to compare the first and second virtual models, generates the list including the first and second sets of names;
generates a second list of names of all of the object blocks that are in the first virtual model;
generates a third list of names of all of the object blocks that are in the second virtual model; and
generates a fourth list of names of object blocks that are in both the first and second virtual models.

3. The virtual modeling system of claim 2 wherein the UI module further:
generates a first tree diagram with the names in the second list;
generates a second tree diagram with the names in the third list; and
displays the first and second tree diagrams on the display.

4. The virtual modeling system of claim 3 wherein the UI module generates the first and second tree diagrams further based on the fourth list and the first and second sets of names.

5. The virtual modeling system of claim 4 wherein the UI module:
displays the names that are in the fourth list using a first visual indicator; and
displays the names that are in the first and second sets using a second visual indicator,
wherein the first and second visual indicators are different.

6. The virtual modeling system of claim 1 wherein the merging module further removes one or more object blocks from the second virtual model that do not exist in the first virtual model.

7. The virtual modeling system of claim 6 wherein the merging module further removes one or more connectors from the second virtual model that do not exist in the first virtual model.

8. The virtual modeling system of claim 1 wherein, in response to user input to merge object blocks from the second virtual model to the first virtual model, the merging module further:
for first ones of the object blocks that do not exist in the first virtual model at the time of the user input to merge the object blocks from the second virtual model to the first virtual model, copies the first ones of the object blocks from the second virtual model to the first virtual model;
for second ones of the object blocks that exist in the first virtual model at the time of the user input to merge the object blocks from the second virtual model to the first virtual model, replaces the second ones of the blocks in the first virtual model with the second ones of the blocks from the second virtual model; and
connects the object blocks in the first virtual model based on connections between the object blocks in the second virtual model.

9. The virtual modeling system of claim 8 wherein the merging module further removes one or more object blocks from the first virtual model that do not exist in the second virtual model.

10. The virtual modeling system of claim 9 wherein the merging module further removes one or more connectors from the first virtual model that do not exist in the second virtual model.

11. A virtual modeling method comprising:
indicating a first virtual model selected by a user;
indicating a second virtual model selected by the user;
generating a list including:
a first set of names of object blocks that are in at least one subsystem of the first virtual model but that are not in at least one subsystem of the second virtual model; and
a second set of names of object blocks that are in the at least one subsystem of the second virtual model but that are not in the at least one subsystem of the first virtual model;
selectively displaying the first and second sets of names on a display; and
in response to user input to merge object blocks from the first virtual model to the second virtual model:
copying the object blocks from the first virtual model to the second virtual model; and
connecting the object blocks in the second virtual model based on connections between the object blocks in the first virtual model.

12. The virtual modeling method of claim 11 further comprising:
in response to user input to compare the first and second virtual models, generating the list including the first and second sets of names;
generating a second list of names of all of the object blocks that are in the first virtual model;
generating a third list of names of all of the object blocks that are in the second virtual model; and
generating a fourth list of names of object blocks that are in both the first and second virtual models.

13. The virtual modeling method of claim 12 further comprising:
generating a first tree diagram with the names in the second list;
generating a second tree diagram with the names in the third list; and
displaying the first and second tree diagrams on the display.

14. The virtual modeling method of claim 13 further comprising generating the first and second tree diagrams further based on the fourth list and the first and second sets of names.

15. The virtual modeling method of claim 14 further comprising:
displaying the names that are in the fourth list using a first visual indicator; and
displaying the names that are in the first and second sets using a second visual indicator,
wherein the first and second visual indicators are different.

16. The virtual modeling method of claim 11 further comprising removing one or more object blocks from the second virtual model that do not exist in the first virtual model.

17. The virtual modeling method of claim 16 further comprising removing one or more connectors from the second virtual model that do not exist in the first virtual model.

18. The virtual modeling method of claim 11 further comprising, in response to user input to merge object blocks from the second virtual model to the first virtual model:
for first ones of the object blocks that do not exist in the first virtual model at the time of the user input to merge the object blocks from the second virtual model to the first virtual model, copying the first ones of the object blocks from the second virtual model to the first virtual model;
for second ones of the object blocks that exist in the first virtual model at the time of the user input to merge the object blocks from the second virtual model to the first virtual model, replacing the second ones of the blocks in the first virtual model with the second ones of the blocks from the second virtual model; and
connecting the object blocks in the first virtual model based on connections between the object blocks in the second virtual model.

19. The virtual modeling method of claim 18 further comprising removing one or more object blocks from the first virtual model that do not exist in the second virtual model.

20. The virtual modeling method of claim 19 further comprising removing one or more connectors from the first virtual model that do not exist in the second virtual model.
